(19) United States
(12) Patent Application Publication
(10) Pub. No.: US 2021/0356583 A1
(43) Pub. Date: Nov. 18, 2021

(54) OBJECT DETECTION APPARATUS AND OBJECT DETECTION METHOD

(71) Applicants: DENSO CORPORATION, Kariya-city (JP); TOYOTA JIDOSHA KABUSHIKI KAISHA, Toyota-shi (JP)

(72) Inventors: Shinji KUTOMI, Kariya-city (JP); Yuki MINASE, Toyota-shi (JP); Motonari OHBAYASHI, Toyota-shi (JP); Masumi FUKUMAN, Kariya-city (JP)

(21) Appl. No.: 17/337,253

(22) Filed: Jun. 2, 2021

Related U.S. Application Data
(63) Continuation of application No. PCT/JP2019/033111, filed on Aug. 23, 2019.

(30) Foreign Application Priority Data
Dec. 4, 2018 (JP) 2018-227571

(51) Int. Cl. G01S 15/10; G01S 7/527; B60W 40/00

(52) U.S. Cl. CPC G01S 15/101; B60W 2420/54; B60W 40/00; G01S 7/527

(57) ABSTRACT

An object detection apparatus is mounted to a moving body to which a plurality of distance measurement sensors are mounted, and detects an object that is present in a vicinity of the moving body. In response to direct waves and indirect waves being received, the object detection apparatus acquires a relative position of an object to a moving body based on principles of triangulation using distance measurement information based on the direct waves and distance measurement information based on the indirect waves. In response to the received waves being reflected waves from an object of which the relative position has been already acquired and only either of the direct waves and the indirect waves being received as received waves, the object detection apparatus estimates the relative position of the object to the moving body based on a reference position that is the relative position that has been already acquired.

### CROSS-REFERENCE TO RELATED APPLICATIONS

The present application is a continuation application of International Application No. PCT/JP2019/033111, filed on Aug. 23, 2019, which claims priority to Japanese Patent Application No. 2018-227571, filed on Dec. 4, 2018. The contents of these applications are incorporated herein by reference in their entirety.

### BACKGROUND

### Technical Field

The present disclosure relates to an object detection apparatus and an object detection method.

### Related Art

An object detection apparatus, which is mounted to a moving body and detects an object that is present in a vicinity of the moving body, is known. For example, the object detection apparatus is mounted to the moving body such as a vehicle to which a plurality of distance measurement sensors are mounted, and calculates relative positions of the vehicle and an object by triangulation using the plurality of distance measurement sensors.

### SUMMARY

An aspect of the present disclosure provides an object detection apparatus that is mounted to a moving body to which a plurality of distance measurement sensors are mounted, and detects an object that is present in a vicinity of the moving body. In response to direct waves and indirect waves being received, the object detection apparatus acquires a relative position of an object to a moving body based on principles of triangulation using distance measurement information based on the direct waves and distance measurement information based on the indirect waves. In response to the received waves being reflected waves from an object of which the relative position has been already acquired and only either of the direct waves or the indirect waves being received as received waves, the object detection apparatus estimates the relative position of the object to the moving body based on a reference position that is the relative position that has been already acquired.

### BRIEF DESCRIPTION OF THE DRAWINGS

FIG. 1 is a plan view of an overall configuration of a vehicle to which an object detection apparatus according to an embodiment is mounted;

FIG. 2 is a block diagram of an overall functional configuration of the object detection apparatus shown in FIG. 1;

FIG. 3 is a conceptual diagram illustrating an example of operation of the object detection apparatus shown in FIG. 2;

FIG. 4 is a flowchart illustrating an example of operation of the object detection apparatus shown in FIG. 2; and

FIG. 5 is a flowchart illustrating an example of operation of the object detection apparatus shown in FIG. 2.

### DESCRIPTION OF THE EMBODIMENTS

The present disclosure relates to an object detection apparatus that is mounted to the moving body and detects an object that is present in a vicinity of the moving body. In addition, the present disclosure relates to an object detection method for detecting an object that is present in a vicinity of a moving body.

An object detection apparatus described in JP-A-2016-080641 calculates relative positions of a vehicle that is a moving body and an object through triangulation using a plurality of distance measurement sensors.

Specifically, the object detection apparatus includes a first detecting unit, a second detecting unit, a position calculating unit, and an invalidating unit. The first detecting unit detects an object by direct waves. The direct waves are received waves in a case in which a distance measurement sensor that transmits probe waves and a distance measurement sensor that receives reflected waves of the probe waves from an object as the received waves are the same. The second detecting unit detects an object by indirect waves. The indirect waves are received waves in a case in which a distance measurement sensor that transmits probe waves and a distance measurement sensor that receives reflected waves of the probe waves from an object as the received waves differ. The position calculating unit calculates positional information of an object based on principles of triangulation, based on detection results from the first detecting unit and the second detecting unit. The invalidating unit invalidates the positional information based on a positional relationship between an overlapping detection range in which a detection range of the direct waves and a detection range of the indirect waves overlap, and the positional information calculated by the position calculating unit.

A range over which object detection can be performed by triangulation using two distance measurement sensors is the overlapping detection range in which the detection range of the direct waves and the detection range of the indirect waves overlap. Therefore, if the positional information of the object that is calculated based on the principles of triangulation is correct, a calculation result of the positional information of the object should be within the overlapping detection range. With focus on this point, in the configuration described in JP-A-2016-080641, the positional information is invalidated based on the positional relationship between the positional information of the object that is calculated based on the principles of triangulation and the overlapping detection range. As a result of this configuration, erroneous detection of an object can be suppressed.

In object position detection by triangulation using two distance measurement sensors among a plurality of distance measurement sensors, such as that described above, the detection range becomes narrower than that in distance detection using a single specific distance measurement sensor among a plurality of distance measurement sensors. In particular, for example, depending on the application or circumstance of object detection, it may be preferable for an object to be continuously detected, even when the relative position of the object moves from a position in which triangulation is established to a position in which triangulation is not established.

It is thus desired to provide an object detection apparatus that is capable of more favorably performing object detection when triangulation is not established than in the past, and an object detection method.

A first exemplary embodiment of the present disclosure provides an object detection apparatus that is mounted to a moving body to which a plurality of distance measurement sensors are mounted and detects an object that is present in a vicinity of the moving body. Each of the distance measurement sensors outputs distance measurement information that corresponds to a distance to the object by transmitting probe waves externally from the moving body and receiving waves, as received waves, that include reflected waves of the probe waves from the object.

The object detection apparatus includes an object position acquiring unit and an object position estimating unit. In response to direct waves and indirect waves being received, the object position acquiring unit acquires a relative position of the object to the moving body based on principles of triangulation using the distance measurement information based on the direct waves and the distance measurement information based on the indirect waves. The direct waves are the received waves of a first distance measurement sensor that is one of the plurality of distance measurement sensors and are the reflected waves of the probe waves that are transmitted from the first distance measurement sensor. The indirect waves are the received waves of a second distance measurement sensor that is another of the plurality of distance measurement sensors and are the reflected waves of the probe waves that are transmitted from the first distance measurement sensor. In response to the received waves being the reflected waves from the object of which the relative position has been already acquired by the object position acquiring unit and only either of the direct waves or the indirect waves being received as the received waves, the object position estimating unit estimates the relative position based on a reference position that is the relative position that has been already acquired.

A second exemplary embodiment of the present disclosure provides an object detection method that is usable for a moving body to which a plurality of distance measurement sensors are mounted and detects an object that is present in a vicinity of the moving body. Each of the distance measurement sensors outputs distance measurement information that corresponds to a distance to the object by transmitting probe waves externally from the moving body and receiving waves, as received waves, that include reflected waves of the probe waves from the object.

The object detection method includes following steps: (i) acquiring, in response to direct waves and indirect waves being received, a relative position of the object to the moving body based on principles of triangulation using the distance measurement information based on the direct waves and the distance measurement information based on the indirect waves, the direct waves being the received waves of a first distance measurement sensor that is one of the plurality of distance measurement sensors and being the reflected waves of the probe waves that are transmitted from the first distance measurement sensor, and the indirect waves being the received waves of a second distance measurement sensor that is another of the plurality of distance measurement sensors and being the reflected waves of the probe waves that are transmitted from the first distance measurement sensor; and (ii) estimating, in response to and the received waves are the reflected waves from the object of which the relative position has been already acquired by the object position acquiring unit and only either of the direct waves or the indirect waves is received as the received waves, the relative position based on a reference position that is the relative position that has been already acquired.

In the above-described configuration, the direct waves and the indirect waves may both be received while an object detection operation using the first distance measurement sensor and the second distance measurement sensor is being performed. In this case, the object position acquiring unit acquires the relative position of the object to the moving body based on the principles of triangulation using the distance measurement information corresponding to the direct waves and the distance measurement information corresponding to the indirect waves.

Meanwhile, triangulation may not be established while the object detection operation is being performed. In this case, the relative position of the object to the moving body cannot be acquired based on the principles of triangulation. However, even in this case, either of the direct waves and the indirect waves may be received as the received waves. If the received waves are that of the reflected waves from the object of which the relative position has been already acquired, a likelihood that the object is present near the relative position that has been already acquired is high.

Therefore, even when triangulation is not established, the object position estimating unit estimates the relative position based on a reference position that is the relative position that has been already acquired when both of the following conditions are met.

Condition 1: Either of the direct waves and the indirect waves are received as the received waves.

Condition 2: The received waves are reflected waves from the object B of which the position has been already acquired or already estimated.

In a similar manner, the above-described method acquires the relative position of the object to the moving body based on the principles of triangulation using the distance measurement information based on the direct waves and the distance measurement information based on the indirect waves, when triangulation is established. Meanwhile, when triangulation is not established, the above-described method estimates the relative position based on the reference position that is the relative position that has been already acquired when the above-described conditions are met.

In this manner, as a result of the above-described configuration and the above-described method, even when triangulation is not established, when the likelihood of the object being present near the relative position that has been already acquired is high, object detection, that is, estimation of the relative position is favorably performed. Consequently, object detection when triangulation is not established can be more favorably performed than in the past.

Here, reference numbers in parentheses may be attached to elements in the application documents. However, even in this case, the reference numbers merely indicate examples of corresponding relationships between the elements and specific unit described according to embodiments described hereafter. Therefore, the present disclosure is not limited in any way by the above-described reference numbers.

An embodiment of the present disclosure will hereinafter be described with reference to the drawings. Here, because understanding of the embodiment may be hindered as a result of the modifications being mixed with description related to a series of descriptions related to the embodiment, various modifications that are applicable to the embodiment will be collectively described following the descriptions of the embodiment.

### (Configuration)

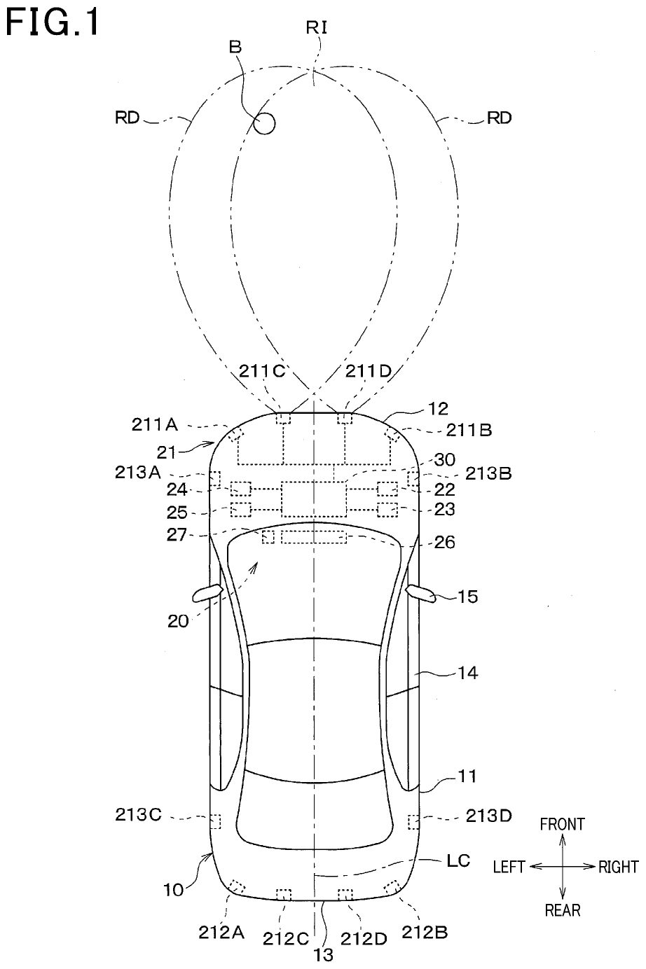

With reference to FIG. 1, a vehicle 10 that serves as a moving body is a so-called four-wheeled automobile and includes vehicle body 11 that has a substantially rectangular shape in a plan view. Hereafter, a virtual line that passes through a center of the vehicle 10 in a vehicle width direction and is parallel to an overall vehicle length direction of the vehicle 10 in a plan view is referred to as a vehicle center line LC. The overall vehicle length direction is a direction that is orthogonal to the vehicle width direction and orthogonal to a vehicle height direction. The vehicle height direction is a direction that prescribes a vehicle height of the vehicle 10 and is a direction that is parallel to a direction of gravitational action when the vehicle 10 is placed on a horizontal surface. In FIG. 1, the overall vehicle length direction is an up/down direction (vertical direction) in the drawing and the vehicle width direction is a left/right direction (horizontal direction) in the drawing.

In FIG. 1, “front,” “rear,” “left,” and “right” of the vehicle 10 are defined as indicated by arrows. That is, the overall vehicle length direction is synonymous with a front/rear direction. In addition, the vehicle width direction is synonymous with a left/right direction. A shape of each section “in a plan view” indicates a shape when the section is viewed from above the vehicle 10, with a line of sight that is parallel to the vehicle height direction.

A front bumper 12 is mounted in an end portion on the front side of the vehicle body 11. A rear bumper 13 is mounted in an end portion on the rear side of the vehicle body 11. A door panel 14 is mounted in a side surface portion of the vehicle body 11. In a specific example shown in FIG. 1, two door panels 14 each on the left and right, that is, a total of four door panels 14, are provided. A door mirror 15 is mounted in each of the pair of left and right door panels 14 on the front side.

An object detection apparatus 20 is mounted to the vehicle 10. The vehicle 10 to which the object detection apparatus 20 according to the present embodiment is mounted may be referred to, hereafter, as an “own vehicle.” The object detection apparatus 20 is mounted to the own vehicle and detects an object B that is present in a vicinity of the own vehicle. Specifically, the object detection apparatus 20 includes a distance measurement sensor 21, a vehicle speed sensor 22, a shift position sensor 23, a steering angle sensor 24, a yaw rate sensor 25, a display 26, a warning sound generator 27, and an electronic control apparatus 30. Here, to simplify the drawing, electrical connection relationships among the section configuring the object detection apparatus 20 are omitted as appropriate in FIG. 1.

The distance measurement sensor 21 is provided so as to output distance measurement information by transmitting probe waves externally from the own vehicle and receiving waves, as received waves, that include reflected waves of the probe waves from the object B. The distance measurement information is information that is included in an output signal of the distance measurement sensor 21 and is information that corresponds to a distance to the object B that is in the vicinity of the own vehicle. According to the present embodiment, the distance measurement sensor 21 is a so-called ultrasonic sensor, and is configured to transmit probe waves that are ultrasonic waves and be capable of receiving waves, as received waves, that include the ultrasonic waves.

The object detection apparatus 20 includes a plurality of distance measurement sensors 21. That is, a plurality of distance measurement sensors 21 are mounted to the vehicle 10. The plurality of distance measurement sensors 21 are each provided in positions that differ from one another, in a plan view. In addition, according to the present embodiment, the plurality of distance measurement sensors 21 are each arranged so as to be shifted (offset) to either side in the vehicle width direction from the vehicle center line LC.

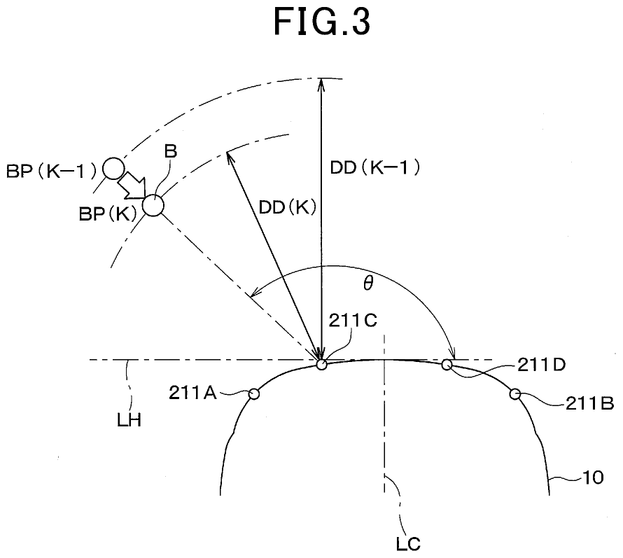

Specifically, according to the present embodiment, a plurality of front sonars 211, i.e., a first front sonar 211A, a second front sonar 211B, a third front sonar 211C, and a fourth front sonar 211D that serve as the distance measurement sensors 21 are mounted to the front bumper 12. In a similar manner, a plurality of rear sonars 212, i.e., a first rear sonar 212A, a second rear sonar 212B, a third rear sonar 212C, and a fourth rear sonar 212D that serve as the distance measurement sensors 21 are mounted to the rear bumper 13. In addition, a plurality of side sonars 213, i.e, a first side sonar 213A, a second side sonar 213B, a third side sonar 213C, and a fourth side sonar 213D are mounted to the side surface portions of the vehicle body 11. Further, other sonars 214 are mounted to other appropriate portions of the vehicle body 11 (not shown in FIG. 3, below). In the description hereafter, when a sonar among the first front sonar 211A and the like described above is not specified, an expression “distance measurement sensor 21” is used.

One of the plurality of distance measurement sensors 21 is referred to as a “first distance measurement sensor,” another is referred to as a “second distance measurement sensor,” and the “direct waves” and the “indirect waves” are defined in a following manner.

The received waves of the probe waves that are both transmitted by the first distance measurement sensor and received by the first distance measurement sensor, after being reflected by the the object B, are referred to as the “direct waves.” The direct waves are typically the received waves in a case in which the reflected waves from the object B of the probe waves that are transmitted from the first distance measurement sensor are received by the first distance measurement sensor as the received waves. That is, the direct waves are the received waves in a case in which the distance measurement sensor 21 that transmits the probe waves and the distance measurement sensor 21 that receives the reflected waves of the probe waves from the object B as the received waves are the same.

In contrast, the received waves of the probe waves that are transmitted by the first distance measurement sensor and received by the second distance measurement sensor, after being reflected by the object B are referred to as the “indirect waves.” The indirect waves are typically the received waves in a case in which the reflected waves from the object B of the probe waves that are transmitted from the first distance measurement sensor are received by the second distance measurement sensor as the received waves. That is, the indirect waves are the received waves in a case in which the distance measurement sensor 21 that transmits the probe waves and the distance measurement sensor 21 that receives the reflected waves of the probe waves from an object differ.

FIG. 1 shows a direct wave range RD and an indirect wave range RI of two distance measurement sensors 21, with the third front sonar 211C and the fourth front sonar 211D as examples. The direct wave range RD is a range over which, when the object B is present, the direct waves that are attributed to the object B can be received. The indirect wave range RI is a range over which, when the object B is present, the indirect waves that are attributed to the object B can be received. Specifically, while the indirect wave range RI does not completely coincide with a range in which the direct wave ranges RD of the two distance measurement sensors 21 overlap, a large portion does overlap. Hereafter, to simplify the description, the indirect wave range RI is considered to be that which substantially coincides with the range in which the direct wave ranges RD of the two distance measurement sensors 21 overlap.

The first front sonar 211A is provided in a left end portion on a front side surface of the front bumper 12 so as to transmit probe waves ahead and to the left of the own vehicle. The second front sonar 211B is provided in a right end portion on the front side surface of the front bumper 12 so as to transmit the probe waves ahead and to the right of the own vehicle. The first front sonar 211A and the second front sonar 211B are symmetrically arranged with the vehicle center line LC therebetween.

The third front sonar 211C and the fourth front sonar 211D are arrayed in the vehicle width direction in positions closer to the center on the front side surface of the front bumper 12. The third front sonar 211C is arranged between the first front sonar 211A and the vehicle center line LC in the vehicle width direction so as to transmit probe waves substantially ahead of the own vehicle. The fourth front sonar 211D is arranged between the second front sonar 211B and the vehicle center line LC in the vehicle width direction so as to transmit probe waves substantially ahead of the own vehicle. The third front sonar 211C and the fourth front sonar 211D are symmetrically arranged with the vehicle center line LC therebetween.

As described above, the first front sonar 211A and the third front sonar 211C are arranged in positions that differ from each other in a plan view. In addition, the first front sonar 211A and the third front sonar 211C that are adjacent to each other in the vehicle width direction are provided to mutually have a positional relationship in which the reflected waves from the object B of the probe waves transmitted from one can be received as the received waves by the other.

That is, the first front sonar 211A is arranged to be capable of receiving both the direct waves that correspond to the probe waves transmitted by itself and the indirect waves that correspond to the probe waves transmitted by the third front sonar 211C. In a similar manner, the third front sonar 211C is arranged to be capable of receiving both the direct waves that correspond to the probe waves transmitted by itself and the indirect waves that correspond to the probe waves transmitted by the first front sonar 211A.

In a similar manner, the third front sonar 211C and the fourth front sonar 211D are arranged in positions that differ from each other in a plan view. In addition, the third front sonar 211C and the fourth front sonar 211D that are adjacent to each other in the vehicle width direction are provided to mutually have a positional relationship in which the reflected waves from the object B of the probe waves transmitted from one can be received as the received waves by the other.

In a similar manner, the second front sonar 211B and the fourth front sonar 211D are arranged in positions that differ from each other in a plan view. In addition, the second front sonar 211B and the fourth front sonar 211D that are adjacent to each other in the vehicle width direction are provided to mutually have a positional relationship in which the reflected waves from the object B of the probe waves transmitted from one can be received as the received waves by the other.

The first rear sonar 212A is provided in a left end portion on a rear side surface of the rear bumper 13 so as to transmit probe waves to the rear left of the own vehicle. The second rear sonar 212B is provided in a right end portion on the rear side surface of the rear bumper 13 so as to transmit probe waves to the rear right of the own vehicle. The first rear sonar 212A and the second rear sonar 212B are symmetrically arranged with the vehicle center line LC therebetween.

The third rear sonar 212C and the fourth rear sonar 212D are arrayed in the vehicle width direction in positions closer to the center on the rear side surface of the rear bumper 13. The third rear sonar 212C is arranged between the first rear sonar 212A and the vehicle center line LC in the vehicle width direction so as to transmit probe waves substantially to the rear of the own vehicle. The fourth rear sonar 212D is arranged between the second rear sonar 212B and the vehicle center line LC in the vehicle width direction so as to transmit probe waves substantially to the rear of the own vehicle. The third rear sonar 212C and the fourth rear sonar 212D are symmetrically arranged with the vehicle center line LC therebetween.

As described above, the first rear sonar 212A and the third rear sonar 212C are arranged in positions that differ from each other in a plan view. In addition, the first rear sonar 212A and the third rear sonar 212C that are adjacent to each other in the vehicle width direction are provided to mutually have a positional relationship in which the reflected waves from the object B of the probe waves transmitted from one can be received as the received waves by the other.

That is, the first rear sonar 212A is arranged to be capable of receiving both the direct waves that correspond to the probe waves transmitted by itself and the indirect waves that correspond to the probe waves transmitted by the third rear sonar 212C. In a similar manner, the third rear sonar 212C is arranged to be capable of receiving both the direct waves that correspond to the probe waves transmitted by itself and the indirect waves that correspond to the probe waves transmitted by the first rear sonar 212A.

In a similar manner, the third rear sonar 212C and the fourth rear sonar 212D are arranged in positions that differ from each other in a plan view. In addition, the third rear sonar 212C and the fourth rear sonar 212D that are adjacent to each other in the vehicle width direction are provided to mutually have a positional relationship in which the reflected waves from the object B of the probe waves transmitted from one can be received as the received waves by the other.

In a similar manner, the second rear sonar 212B and the fourth rear sonar 212D are arranged in positions that differ from each other in a plan view. In addition, the second rear sonar 212B and the fourth rear sonar 212D that are adjacent to each other in the vehicle width direction are provided to mutually have a positional relationship in which the reflected waves from the object B of the probe waves transmitted from one can be received as the received waves by the other.

The first side sonar 213A, the second side sonar 213B, the third side sonar 213C, and the fourth side sonar 213D are provided so as to transmit probe waves from a side surface of the vehicle body 11 to the side of the own vehicle. The first side sonar 213A and the second side sonar 213B are mounted in front side portions of the vehicle body 11. The first side sonar 213A and the second side sonar 213B are symmetrically arranged with the vehicle center line LC therebetween. The third side sonar 213C and the fourth side sonar 213D are mounted in rear side portions of the vehicle body 11. The third side sonar 213C and the fourth side sonar 213D are symmetrically arranged with the vehicle center line LC therebetween.

The first side sonar 213A is arranged between the first front sonar 211A and the door mirror 15 on the left side in a front/rear direction so as to transmit probe waves to the left of the own vehicle. The first side sonar 213A is provided to mutually have a positional relationship with the first front sonar 211A in which the reflected waves from the object B of the probe waves transmitted from one can be received as the received waves by the other.

The second side sonar 213B is arranged between the second front sonar 211B and the door mirror 15 on the right side in a front/rear direction so as to transmit probe waves to the right of the own vehicle. The second side sonar 213B is provided to mutually have a positional relationship with the second front sonar 211B in which the reflected waves from the object B of the probe waves transmitted from one can be received as the received waves by the other.

The third side sonar 213C is arranged between the first rear sonar 212A and the door panel 14 on the rear left side in a front/rear direction so as to transmit probe waves to the left of the own vehicle. The third side sonar 213C is provided to mutually have a positional relationship with the first rear sonar 212A in which the reflected waves from the object B of the probe waves transmitted from one can be received as the received waves by the other.

The fourth side sonar 213D is arranged between the second rear sonar 212B and the door panel 14 on the rear right side in a front/rear direction so as to transmit probe waves to the right of the own vehicle. The fourth side sonar 213D is provided to mutually have a positional relationship with the second rear sonar 212B in which the reflected waves from the object B of the probe waves transmitted from one can be received as the received waves by the other.

Each of the plurality of distance measurement sensors 21 is connected to the electronic control apparatus 30. That is, each of the plurality of distance measurement sensors 21 is provided to transmit and receive ultrasonic waves under control of the electronic control apparatus 30. In addition, each of the plurality of distance measurement sensors 21 generates an output signal that corresponds to a reception result of the received waves and transmits the output signal to the electronic control apparatus 30.

The vehicle speed sensor 22, the shift position sensor 23, the steering angle sensor 24, and the yaw rate sensor 25 are electrically connected to the electronic control apparatus 30. The vehicle speed sensor 22 is provided to generate a signal that corresponds to a traveling speed of the own vehicle and transmit the signal to the electronic control apparatus 30. The traveling speed of the own vehicle is simply referred to, hereafter, as “vehicle speed.” The shift position sensor 23 is provided to generate a signal that corresponds to a shift position of the own vehicle and transmit the signal to the electronic control apparatus 30. The steering angle sensor 24 is provided to generate a signal that corresponds to a steering angle of the own vehicle and transmit the signal to the electronic control apparatus 30. The yaw rate sensor 25 is provided to generate a signal that corresponds to a yaw rate that acts on the own vehicle and transmit the signal to the electronic control apparatus 30.

The display 26 and the warning sound generator 27 are arranged inside a vehicle cabin of the vehicle 10. The display 26 is electrically connected to the electronic control apparatus 30 so as to perform display that accompanies an object detection operation under the control of the electronic control apparatus 30. The warning sound generator 27 is electrically connected to the electronic control apparatus 30 so as to generate a warning sound that accompanies the object detection operation under the control of the electronic control apparatus 30.

The electronic control apparatus 30 is arranged on an inner side of the vehicle body 11. The electronic control apparatus 30 is configured to perform the object detection operation based on signals and information received from each of the plurality of distance measurement sensors 21, the vehicle speed sensor 22, the shift position sensor 23, the steering angle sensor 24, the yaw rate sensor 25, and the like.

According to the present embodiment, the electronic control apparatus 30 is a so-called onboard microcomputer and includes a central processing unit (CPU), a read-only memory (ROM), a random access memory (RAM), a non-volatile RAM, and the like (not shown). For example, the non-volatile RAM is a flash ROM. The CPU, the ROM, the RAM, and the non-volatile RAM of the electronic control apparatus 30 are simply abbreviated hereafter to “CPU,” “ROM,” “RAM,” and “non-volatile RAM.”

The electronic control apparatus 30 is configured to be capable of actualizing various control operations by the CPU a program from the ROM or the non-volatile RAM and running the program. This program includes that which corresponds to each routine described hereafter. In addition, various types of data that are used to run the program are stored in advance in the ROM or the non-volatile RAM. For example, the various types of data include initial values, a look-up table, a map, and the like.

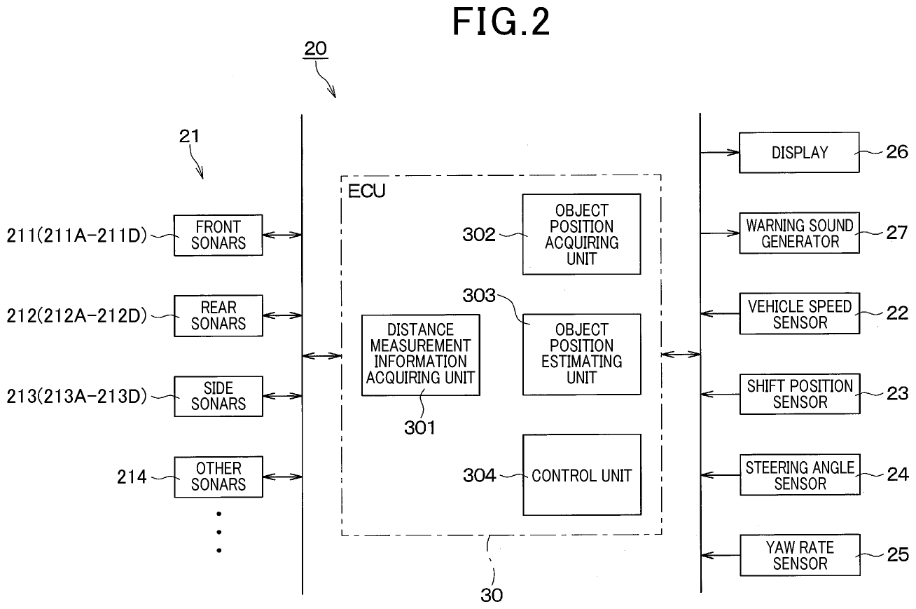

As shown in FIG. 2, the electronic control apparatus 30 includes, as a functional configuration, a distance measurement information acquiring unit 301, an object position acquiring unit 302, an object position estimating unit 303, and a control unit 304. Hereafter, the functional configuration of the electronic control apparatus 20 shown in FIG. 2 will be described.

The distance measurement acquiring unit 301 is provided so as to acquire the distance measurement information outputted from each of the distance measurement sensors 21. That is, the distance measurement acquiring unit 301 temporarily stores, in time-series, the distance measurement information received from each of the plurality of distance measurement sensors 21 amounting to a predetermined period.

The object position acquiring unit 302 is provided to acquire a relative position of the object B to the own vehicle when both the direct waves and the indirect waves are received and triangulation is established. That is, the object position acquiring unit 302 acquires the relative position of the object B to the own vehicle based on the principles of triangulation using the distance measurement information based on the direct waves and the distance measurement information based on the indirect waves. The relative position of the object B to the own vehicle is referred to, hereafter, as a “position of the object B” or as simply a “position”. Details of an operation of the object position acquiring unit 302 will be described hereafter.

The object position estimating unit 303 is provided so as to estimate the position of the object B based on a reference position when both of a condition 1 and a condition 2, below, are established, even when triangulation is not established. The “reference position” is the position of the object B that has been already acquired by the object position acquiring unit 302 or already estimated by the object position estimating unit 303. Here, according to the present embodiment, the reference position does not include that which corresponds to the object B that is temporarily lost. The reference position is typically a valid (that is, has not been lost) and newest position among the positions of the object B that are already acquired by the object position acquiring unit 302 or already estimated by the object position estimating unit 303. In addition, an “object B” in condition 2 does not include an object B that is temporarily lost. Details of an operation of the object position estimating unit 303 will be described hereafter.

Condition 1: Either of the direct waves and the indirect waves is received as the received waves.

Condition 2: The received waves are the reflected waves from the object B of which the position has been already acquired or already estimated.

The control unit 304 is provided so as to control an operation of the overall object detection apparatus 20. That is, the control unit 304 controls transmission and reception timings of each of the plurality of distance measurement sensors 21. In addition, the control unit 304 selectively operates the object position acquiring unit 302 and the object position estimating unit 303 based on states of reception of the direct waves and the indirect waves. Furthermore, the control unit 304 operates the display 26 and/or the warning sound generator 27 based on an acquisition result of the object position acquiring unit 302 and an estimation result of the object position estimating unit 303.

### (Operation Overview)

An operation overview of the object detection apparatus 20 will be described below with reference to a specific operation example.

The electronic control apparatus 30 acquires a vehicle movement state based on outputs from the vehicle speed sensor 22, the shift position sensor 23, the steering angle sensor 24, the yaw rate sensor 25, and the like. The vehicle movement state is a state of movement of the own vehicle that is acquired by the vehicle speed sensor 22, the shift position sensor 23, the steering angle sensor 24, and the yaw rate sensor 25. The vehicle movement state can also be referred to as a “traveling state.” The vehicle movement state includes a stopped state, that is, a state in which the vehicle speed is 0 km/h. The vehicle movement state includes an advancing direction and an advancing speed of the own vehicle. The advancing direction of the own vehicle is referred to, hereafter, as a “vehicle advancing direction.” The vehicle movement state corresponds to a state of movement of each of the plurality of distance measurement sensors 21.

The electronic control apparatus 30 determines an arrival of an object detection timing of a predetermined sensor combination at a predetermined time interval from a point in time when an operation condition of the object detection apparatus 20 is met. For example, the “operation condition” includes the vehicle speed being within a predetermined range.

The “predetermined sensor combination” is a combination of the first distance measurement sensor, when one of the plurality of distance measurement sensors 21 is selected as the first distance measurement sensor, and at least another distance measurement sensor 21 that may serve as the second distance measurement sensor. Specifically, for example, a case in which the third front sonar 211C is selected as the first distance measurement sensor is assumed. In this case, the “predetermined sensor combination” includes the third front sonar 211C that serves as the first distance measurement sensor and others of the plurality of distance measurement sensors 21 that may serve as the second distance measurement sensor. The “others of the plurality of distance measurement sensors 21” are the first front sonar 211A, the second side sonar 213B, and the fourth front sonar 211D. The “predetermined sensor combination” may also be referred to as “selection of a predetermined first distance measurement sensor.”

The “object detection timing” is a specific point in time at which the position of the object B is acquired or estimated using the predetermined sensor combination. That is, the object detection timing is a start time of a routine, described hereafter, for detecting the object B.

The object detection timing arrives at a predetermined time T (such as 200 msec) interval after the operation condition of the object detection apparatus 20 is met, for each predetermined sensor combination. That is, at a predetermined time T cycle, the electronic control apparatus 30 successively selects the first distance measurement sensor from the plurality of distance measurement sensors 21, and performs transmission of probe waves and reception of direct waves and indirect waves by the selected first distance measurement sensor. Therefore, when a number of distance measurement sensors 21 that may serve as the first distance measurement sensor is M, the object detection timing arrives every T/M in the object detection apparatus 20.

When the object detection timing arrives, the electronic control apparatus 30 performs the object detection operation. Specifically, the electronic control apparatus 30 selects a predetermined distance measurement sensor 21 among the plurality of distance measurement sensors 21 as the first distance measurement sensor, and transmits the probe waves from the selected first distance measurement sensor. In addition, the electronic control apparatus 30 controls the operation of each of the plurality of distance measurement sensors 21 and receives an output signal that includes the distance measurement information from each of the plurality of distance measurement sensors 21. Then, the distance measurement information acquiring unit 301 acquires the distance measurement information that is outputted from each of the plurality of distance measurement sensors 21. That is, the distance measurement information acquiring unit 301 temporarily stores, in time-series, the distance measurement information received from each of the plurality of distance measurement sensors 21 amounting to a predetermined period. Then, the electronic control apparatus 30 detects the object B based on the acquisition result of the distance measurement information from the distance measurement information acquiring unit 301.

While object detection operation using the first distance measurement sensor and the second distance measurement sensor is performed, the direct waves and the indirect waves may both be received. In this case, the object position acquiring unit 302 acquires the position of the object B based on the principles of triangulation using the distance measurement information based on the direct waves and the distance measurement information based on the indirect waves. Here, “reception” in this case refers to reception to an extent that the distance measurement information can be effectively acquired. Therefore, reception of which reception strength is weak to an extent that the distance measurement information cannot be effectively acquired is not considered to be “reception” referred to herein. Therefore, “reception” referred to herein can be reworded as “reception at a threshold strength or higher” and/or “effective reception.” Alternatively, “reception” referred to herein may be reworded as “favorable reception.”

Meanwhile, triangulation may not be established while the object detection operation is being performed. In this case, the position of the object B cannot be acquired based on the principles of triangulation. However, in this case as well, either of the direct waves and the indirect waves may be received as the received waves. Specifically, whereas the indirect waves are not favorably received, the direct waves may be favorably received. Alternatively, whereas the direct waves are not favorably received, the indirect waves may be favorably received. If the received waves are the reflected waves from the object B of which the position has been already acquired, a likelihood of the object B being present near the position that has been already acquired is high. Here, the meaning of “reception” in this case is also similar to that described above.

An example of a case in which the third front sonar 211C is the first distance measurement sensor will be described with reference to FIG. 1. The position of the object B in FIG. 1 indicates a position at a (K−1)th object detection timing. K is a natural number of 2 or greater. In addition, the own vehicle is traveling at a low speed at a shift position other than reverse, and the object B is a stationary object. In this example, at the (K−1)th object detection timing, the object B is present near an outer edge of the indirect wave range RI of the third front sonar 211C and the fourth front sonar 211D.

In this case, at the (K−1)th object detection timing, triangulation by the third front sonar 211C and the fourth front sonar 211D is established. Therefore, at the (K−1)th object detection timing, the position of the object B is acquired by the object position acquiring unit 302.

The position of the object B changes as a result of movement of the own vehicle from the state shown in FIG. 1 until a next object detection timing at which the third front sonar 211C is the first distance measurement sensor. In addition, a case in which the position of the object B moves outside the indirect wave range RI and enters the direct wave range RD of the third front sonar 211C at a Kth object detection timing is assumed.

At the Kth object detection timing, triangulation is not established. However, the reflected waves from the object B of which the position have been already acquired at the (K−1)th object detection timing can be received by the third front sensor 211C as the direct waves. Therefore, if the direct waves are received by the third front sonar 211C at the Kth object detection timing, the likelihood of the object B being present near the position that has been already acquired is high. At this time, the object B of which the position has been already acquired at the (K−1)th object detection timing and the object B corresponding to the direct waves that are received at the Kth object detection timing are the same. In a similar manner, at a (K+1)th object detection timing as well, if the direct waves are received by the third front sonar 211C, the likelihood of the object B being present near the position that has been already acquired is high.

Here, even when triangulation is not established, the object position estimating unit 303 estimates the position of the object B based on the reference position when both of the following conditions are met.

Condition 1: Either of the direct waves and the indirect waves is received as the received waves.

Condition 2: The received waves are reflected waves from the object B of which the position has been already acquired or already estimated.

According to the present embodiment, the object position estimating unit 303 estimates the position of the object B based on the reference position and the distance measurement information corresponding to the received waves. That is, when only the direct waves are received, the object position estimating unit 303 estimates the position of the object B based on the reference position and a direct wave distance that is the distance measurement information corresponding to the direct waves. Meanwhile, when only the indirect waves are received, the object position estimating unit 303 estimates the position of the object B based on the reference position and an indirect wave distance that is the distance measurement information corresponding to the indirect waves. Specifically, the object position estimating unit 303 estimates the position of the object B based on an orientation of the reference position from the first distance measurement sensor and the distance measurement information corresponding to the received waves. The orientation is a direction in which the object B is present with reference to the first distance measurement sensor, in a plan view.

FIG. 3 schematically shows a concept of an orientation θ and an estimation method for the position of the object B by the object position estimating unit 303. In an example in FIG. 3, the first distance measurement sensor is the third front sonar 211C. An object position BP indicates the acquisition result or the estimation result of the position of the object B. DD indicates the direct wave distance. (K−1) indicates the (K−1)th object detection timing. (K) indicates the Kth object detection timing. According to the present embodiment, the orientation θ is an orientation angle of the object position BP with reference to a reference line LH. The reference line LH is a virtual line that passes through the first distance measurement sensor and is orthogonal to the vehicle center line LC in a plan view. That is, in a plan view, when the object B is present further toward the right side than the first distance measurement sensor and on the reference line LH, the orientation of the object B is 0 degrees. Meanwhile, in a plan view, when the object B is present further toward the left side than the first distance measurement sensor and on the reference line LH, the orientation of the object B is 180 degrees. In addition, in a plan view, when the object B is present on a virtual line that passes through the first distance measurement sensor and is parallel to the vehicle center line LC, the orientation of the object B is 90 degrees.

With reference to FIG. 3, according to the present embodiment, the object position estimating unit 303 estimates an orientation θ(K) that corresponds to the Kth object detection timing based on an orientation θ(K−1) that corresponds to the (K−1)th object detection timing and the vehicle movement state. In addition, the object position estimating unit 303 acquires a direct wave distance DD(K) that corresponds to the Kth object detection timing. Then, the object position estimating unit 303 calculates, as the estimation result of an object position BP(K), an intersection between a virtual line at the orientation θ(K) that passes through the first distance measurement sensor and a radius DD(K) of which the first distance measurement sensor is a center.

In addition, when a difference between the distance measurement information corresponding to the reference position and the distance measurement information corresponding to the received waves is within a predetermined value, the object position estimating unit 303 estimates a relative position. Meanwhile, the object position estimating unit 303 does not estimate the relative position when the difference between the distance measurement information corresponding to the reference position and the distance measurement information corresponding to the received waves exceeds the predetermined value. That is, in this case, estimation of the position of the object B by the object position estimating unit 303 is prohibited. Furthermore, when the difference between the distance measurement information corresponding to the reference position and the distance measurement information corresponding to the received waves exceeds the predetermined value, the control unit 304 invalidates the position of the object B that is acquired and estimated.

In this manner, the apparatus and the method according to the present embodiment is not that which unconditionally estimates the position of the object B even when triangulation is not established. That is, according to the present embodiment, even when triangulation is not established, the position of the object B is estimated when the reflected waves from the object B of which the position have been already acquired or already estimated is received as either of the direct waves or the indirect waves. In addition, the apparatus and the method according to the present embodiment uses the distance measurement information corresponding to the received waves that are received as either of the direct waves and the indirect waves for estimation of the position of the object B. Therefore, according to the present embodiment, even when triangulation is not established, detection of the object B, that is, estimation of the position is favorably performed when the likelihood of the object B being present near the position that has been already acquired is high. Consequently, object detection when triangulation is not established can be more favorably performed than in the past. Specifically, for example, recognizability of a wall or an adjacent vehicle that is sloped at a shallow angle in relation to the vehicle advancing direction is improved from that in the past.

### EXAMPLE

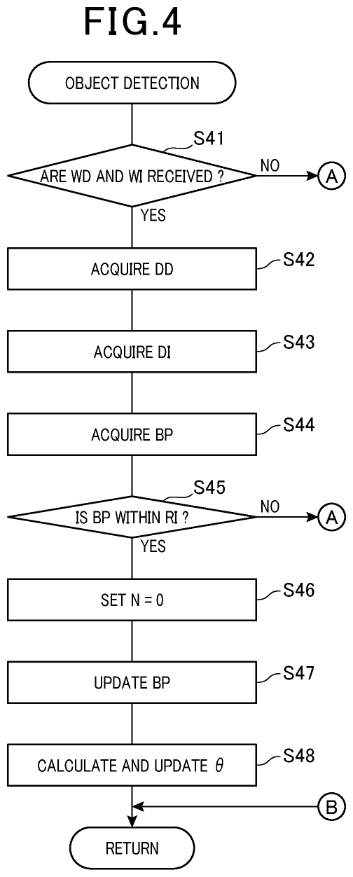

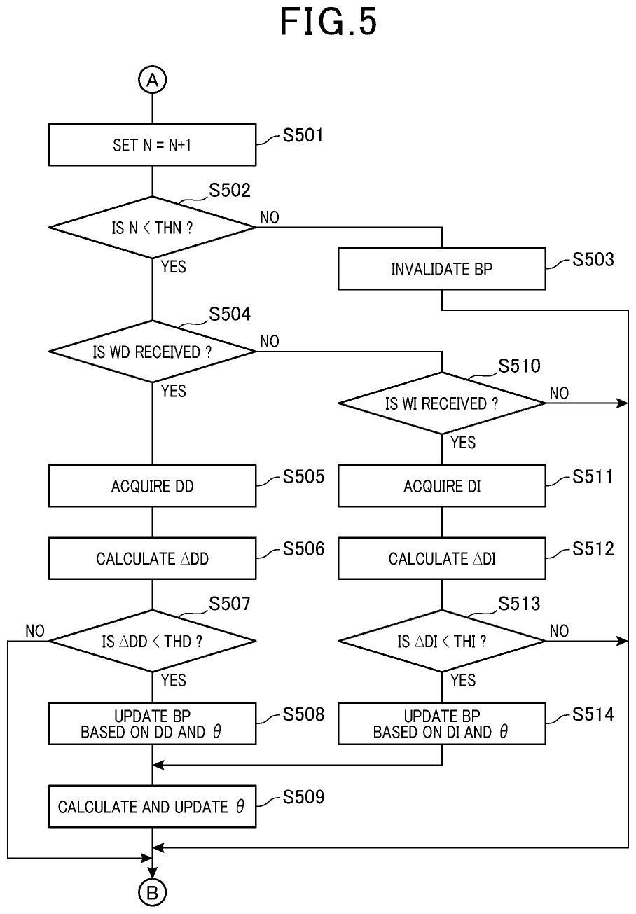

Hereafter, an operation example based on the configuration according to the present embodiment will be described with reference to flowcharts in FIGS. 4 and 5. In the flowcharts in FIGS. 4 and 5, “S” is an abbreviation of “step.”

An object detection routine shown in FIG. 4 is initially started when the operation condition of the object detection apparatus 20 is changed from not met to met. Subsequently, the object detection routine is repeatedly started each time the object detection timing arrives until the operation condition of the object detection apparatus 20 is no longer met.

For example, when the first object detection timing arrives, the CPU selects the first front sonar 211A as the first distance measurement sensor, and starts and performs the object detection routine shown in FIG. 4. When the next object detection timing arrives, the CPU selects the second front sensor 211B as the first distance measurement sensor, and starts and performs the object detection routine shown in FIG. 4. Furthermore, when the next object detection timing arrives, the CPU selects the third front sonar 211C as the first distance measurement sensor, and starts and performs the object detection routine shown in FIG. 4. In this manner, the M distance measurement sensors 21 that can be selected as the first distance measurement sensor are each selected once during the predetermined time T (such as 200 msec).

As a result of the predetermined time T elapsing from the arrival of the first object detection timing, the object detection timing at which the first front sonar 211A is the first distance measurement sensor arrives again. Then, the CPU selects the first front sonar 211A as the first distance measurement sensor again, and starts and performs the object detection routine shown in FIG. 4. When the next object detection timing further arrives, the CPU selects the second front sensor 211B as the first distance measurement sensor again, and starts and performs the object detection routine shown in FIG. 4. Hereafter, in a similar manner, the CPU repeatedly starts and performs the object detection routine shown in FIG. 4 while successively changing the first distance measurement sensor, until the operation condition of the object detection apparatus 20 is no longer met.

When the object detection routine shown in FIG. 4 is started, first, at step S41, the CPU determines whether the direct waves WD and the indirect waves WI are both received. When both the direct waves WD and the indirect waves WI are received (that is, step S41=YES), the CPU successively performs processes at steps S42 to S45. The process at step S41 corresponds to an operation of the control unit 304.

At step S42, the CPU acquires a direct wave distance DD that corresponds to the direct waves WD that is currently received. At step S43, the CPU acquires an indirect wave distance DI that corresponds to the indirect waves WI that are currently received. At step S44, the CPU acquires the object position BP based on the direct wave distance DD and the indirect wave distance ID that are currently acquired. Here, in acquisition of the object position BP at steps S42 to S44, it goes without saying that the vehicle movement state, such as the vehicle speed and the yaw rate, is taken into consideration as appropriate. The processes at steps S42 to S44 correspond to operations of the object position acquiring unit 302.

At step S45, the CPU determines whether the object position BP acquired in the process at the current step S44 is within the indirect wave range RI. When the acquired object position BP is within the indirect wave range RI (that is, step S45=YES), the CPU successively performs processes at steps S46 to S48 and subsequently temporarily ends the present routine. The process at step S45 corresponds to an operation of the object position acquiring unit 302.

At step S46, the CPU resets an estimation counter N (that is, N=0). At step S47, the CPU updates a newest position of the object B with the object position B acquired in the process at the current step S44. At step S48, the CPU calculates the orientation θ of the updated object position BP and updates a value of the newest orientation θ with the calculation result. The process at step S46 corresponds to an operation of the control unit 304. The processes at steps S47 and S48 correspond to operations of the object position acquiring unit 302.

When the condition that both the direct waves WD and the indirect waves WI are received is not met (that is, step S41=NO), the CPU advances the process to step S501 in FIG. 5. This also similarly applies to when the object position BP acquired in the process at the current step S44 is outside the indirect wave range RI (that is, step S45=NO).

At step S502, the CPU increments the estimation counter N. That is, the CPU adds 1 to the estimation counter N. At step S502, the CPU determines whether the estimation counter N is less than a counter threshold THN. In the present example, the counter threshold THN is a natural number 2 or greater. The processes at step S501 and step S502 correspond to operations of the control unit 304.

When the estimation counter N is equal to or greater than the counter threshold THN (that is, step S502=NO), estimation of the object position BP by the object position estimating unit 303 is repeated a predetermined number of times. That is, in this case, acquisition of the object position BP by the object position acquiring unit 302 is continuously not performed a predetermined number of times. In this case, favorable estimation accuracy is difficult to achieve even when estimation of the object position PB by the object position estimating unit 303 is further continued. Therefore, in this case, the CPU performs the process at step S503 and subsequently temporarily ends the present routine.

At step S503, the CPU invalidates the object position BP that has been already acquired and estimated. As a result, the corresponding orientation θ is also invalidated. The process at step S503 can be considered to be a process in which positional information that is acquired and estimated regarding a lost object B is deleted or erased from a storage area. The process at step S503 corresponds to an operation of the control unit 304. The storage area can also be referred to as a memory area.

When the estimation counter N is less than the counter threshold THN (that is, step S502=YES), the CPU advances the process to step S504. At step S504, the CPU determines whether the direct waves WD are received. The process at step S504 corresponds to an operation of the control unit 304.

When the direct waves WD are received (that is, step S504=YES), the CPU successively performs the processes at steps S505 and S506, and subsequently advances the process to step S507. At step S505, the CPU acquires the direct wave distance DD that corresponds to the direct waves WD that are currently received. At step S506, the CPU calculates a difference ΔDD between the direct wave distance DD that corresponds to the newest object position BP that is the reference position and the acquired value at step S505. The processes at steps S505 and S506 correspond to operations of the object position estimating unit 303.

At step S507, the CPU determines whether ΔDD is less than the predetermined value THD. This determination corresponds to a determination as to whether the reflected waves from the object B of which the position have been already acquired or already estimated is received as the direct wave WD. That is, this determination corresponds to a determination as to whether the object B of which the position has been already acquired or already estimated and the object B that corresponds to the direct waves WD that are currently received are the same. The “object B that corresponds to the direct waves WD that are currently received” is the object B that has produced the direct waves WD by reflecting the probe waves that are the source of the direct waves WD that are currently received. The process at step S507 corresponds to an operation of the object position estimating unit 303. When ΔDD is less than the predetermined value THD (that is, step S507=YES), the CPU successively performs the processes at steps S508 and S509, and subsequently temporarily ends the present routine. Meanwhile, when ΔDD is equal to or greater than the predetermined value THD (that is, step S507=NO), the CPU skips the processes at step S508 and step S509, and temporarily ends the present routine.

At step S508, the CPU estimates the object position BP based on the direct wave distance DD that is currently acquired and the newest orientation θ. Details of the estimation method for the object position PB are as described above. In addition, the CPU updates the newest position of the object B with the object position BP that is currently estimated. At step S509, the CPU calculates the orientation θ at the updated object position BP and updates the value of the newest orientation θ with the calculation result. The processes at step S508 and step S509 correspond to operations of the object position estimating unit 303. Here, regarding the processes at steps S505 to S508, it goes without saying that the vehicle movement state, such as the vehicle speed and the yaw rate, is taken into consideration as appropriate.

When the direct waves WD are not received (that is, step S504=NO), the CPU advances the process to step S510. At step S510, the CPU determines whether the indirect waves WI are received. The process at step S510 corresponds to an operation of the control unit 304.

When the indirect waves WI are received (that is, step S510=YES), the CPU successively performs the processes at steps S511 and S512, and subsequently advances the process to step S507. Meanwhile, when neither the direct waves WD nor the indirect waves WI is received (that is, step S510=NO), the CPU skips all processes at step S511 and subsequent steps, and temporarily ends the present routine.

At step S511, the CPU acquires the indirect wave distance DI that corresponds to the indirect waves WI that are currently received. At step S512, the CPU calculates a difference ΔDI between the indirect wave distance DI that corresponds to the newest object position BP that is the reference position and the acquired value at step S511. The processes at steps S511 and S512 correspond to operations of the object position estimating unit 303.

At step S513, the CPU determines whether ΔDI is less than a predetermined value TH1. This determination corresponds to a determination as to whether the reflected waves from the object B of which the position have been already acquired or already estimated are received as the indirect waves WI. That is, this determination corresponds to a determination as to whether the object B of which the position has been already acquired or already estimated and the object B that corresponds to the indirect waves WI that are currently received are the same. The “object B that corresponds to the indirect waves WI that is currently received” is the object B that has produced the indirect waves WI by reflecting the probe waves that are the source of the indirect waves WI that are currently received. The process at step S513 corresponds to an operation of the object position estimating unit 303.

When ΔDI is less than the predetermined value TH1, (that is, step S513=YES), the CPU advances the process to step S514, subsequently advances the process to step S509, and then temporarily ends the present routine. Meanwhile, when ΔDI is equal to or greater than the predetermined value TH1 (that is, step S513=NO), the CPU skips the process at step S514 and temporarily ends the present routine.

At step S514, the CPU estimates the object position BP based on the indirect wave distance DI that is currently acquired and the newest orientation θ. In addition, the CPU updates the newest position of the object B with the object position BP that is currently estimated. The process at step S514 corresponds to an operation of the object position estimating unit 303. Here, regarding the processes at steps S511 to S514, it goes without saying that the vehicle movement state, such as the vehicle speed and the yaw rate, is taken into consideration as appropriate.

### (Modifications)

The present disclosure is not limited to the above-described embodiment. Therefore, modifications can be made as appropriate in the above-described embodiment. Typical modifications will be described below. In the descriptions of modifications below, differences with the above-described embodiment will mainly be described. In addition, sections according to the above-described embodiment and in the modifications that are identical or equivalent to each other are given the same reference numbers. Therefore, in the descriptions of the modifications below, regarding constituent elements of which the reference numbers are the same as those according to the above-described embodiment, the descriptions according to the above-described embodiment are applicable unless technical inconsistencies are present or additional description is particularly given.

The present disclosure is not limited to the specific apparatus configuration described according to the above-described embodiment. That is, for example, the vehicle 10 is not limited to a four-wheeled automobile. Specifically, the vehicle 10 may be a three-wheeled automobile, or a six-wheeled or eight-wheeled automobile such as a cargo truck. The “object” can also be reworded as “obstacle.” That is, the object detection apparatus can also be referred to as an obstacle detection apparatus.

Arrangement and quantity of the distance measurement sensors 21 are not limited to the specific example described above. That is, for example, with reference to FIG. 1, when the third front sonar 211C is arranged in a center position in the vehicle width direction, the fourth front sonar 211D is omitted. In a similar manner, when the third rear sonar 212C is arranged in a center position in the vehicle width direction, the fourth rear sonar 212D is omitted.

The distance measurement sensor 21 is not limited to an ultrasonic sensor. That is, for example, the distance measurement sensor 21 may be a laser radar sensor or a millimeter-wave radar sensor. Acquisition of the vehicle movement state is not limited to a mode in which the vehicle speed sensor 22, the shift position sensor 23, the steering angle sensor 24, and the yaw rate sensor 25 are used. That is, for example, the yaw rate sensor 25 may be omitted. Alternatively, for example, sensors other than those described above may be used for acquisition of the vehicle movement state.

According to the above-described embodiment, the electronic control apparatus 30 is configured such that the CPU reads a program from the ROM or the like and launches the program. However, the present disclosure is not limited to this configuration. That is, for example, the electronic control apparatus 30 may be a digital circuit that is configured to be capable of operations such as those described above, such as an ASIC such as a gate array. ASIC is an abbreviation of Application Specific Integrated Circuit.

The electronic control apparatus 30 may be electrically connected to the vehicle speed sensor 22 and the like over an onboard communication network. The onboard communication network is configured in accordance with an onboard LAN standard such as CAN (international registered trademark), FlexRay (international registered trademark), and the like. CAN (international registered trademark) is an abbreviation of Controller Area Network. LAN is an abbreviation of Local Area Network.

The first side sonar 213A, the second side sonar 213B, the third side sonar 213C, and the fourth side sonar 213D may each be provided to be capable of receiving only the direct waves. Alternatively, the first side sonar 213A, the second side sonar 213B, the third side sonar 213C, and the fourth side sonar 213D may be omitted.

The present disclosure is not limited to the specific operation examples and processing modes described according to the above-described embodiment. For example, the operation overview and operation examples described above correspond to when the own vehicle advances forward. However, the present disclosure is not limited to this embodiment. That is, the present disclosure can be similarly applied to when the own vehicle is in reverse. The first distance sensor and the second distance sensor are typically two distance measurement sensors 21 that are adjacent to each other. However, the present disclosure is not limited to this embodiment. That is, for example, with reference to FIG. 1, triangulation can also be established by the second front sonar 211B and the third front sonar 211C. Therefore, a case in which the second front sonar 211B is the first distance measurement sensor and the third front sonar 211C is the second distance measurement sensor is also possible.

The reference position may not include a relative position that has been already estimated and may only include the relative position that has been already acquired. That is, in the operation example described above, the counter threshold THN=2 at step S402 is also possible. Alternatively, the counter threshold THN may be as small a value as possible that is 3 or greater (such as 3 or 4). That is, when a state in which only either of the direct waves and the indirect waves is received as the received waves continues, the object position estimating unit 303 may use a previous estimation result of the relative position as the reference position instead of the relative position that has been already acquired, for just a predetermined number of times. As a result, favorable object detection accuracy can be ensured.

In the above-described specific example, the object B is described as a stationary object. However, the present disclosure is not limited to this embodiment. That is, it goes without saying that, for example, when the object B is a moving object, an aspect of relative movement between the own vehicle and the object B is taken into consideration in each of the above-described processes.

The reference for the orientation θ may be the vehicle center line LC. At this time, when the object B is present on a virtual line that passes through the first distance measurement sensor and is parallel to the vehicle center line LC in a plan view, the orientation of the object B is 0 degrees.

The process at step S45 can be omitted. That is, the object position acquiring unit 302 may validate the acquired object position BP if both the direct wave and the indirect waves are received, even when the object position BP acquired based on the direct waves and the indirect waves is outside a predetermined range.

Regarding the determination method regarding whether the object B of which the position has been already acquired or already estimated and the object B that corresponds to the direct waves WD that is currently received are the same, as well, the determination method is not limited to that which is based on a distance difference (that is, ΔDD and the like) such as that in the specific example described above. That is, regarding this determination, other information such as reception strength, a frequency modulation state, and the like can be used instead of or in addition to the distance difference.

The process at step S509 can be omitted. That is, when estimation of the object position BP by the object position estimating unit 303 is performed without acquisition of the object position BP by the object position acquiring unit 302 being performed, the orientation θ may not be estimated.

The functional block configuration shown in FIG. 2 is merely an example that is conveniently shown to briefly describe an embodiment of the present disclosure. Therefore, the present disclosure is not limited to the functional block configuration. That is, regarding function arrangements, modifications may be made as appropriate to the specific example shown in FIG. 2. Therefore, corresponding relationships between the processes and the function configuration sections described above in the specific example merely indicate an example and can be modified as appropriate.

“Acquire” can be changed as appropriate to another expression such as “calculate.” This similarly applies to “estimate.” A sign of inequality in each determination process may include include or exclude equality. That is, for example, “equal to or greater than a threshold” may be changed to “exceeds a threshold.”

The modifications are also not limited to the examples described above. In addition, a plurality of modifications may be combined with each other. Furthermore, the above-described embodiment in its entirety or in part, and all or a part of the modifications may be combined with each other.

The functional configurations and method described above may be actualized by a dedicated computer that is provided so as to be configured by a processor and a memory, the processor being programmed to provide one or a plurality of functions that are realized by a computer program. Alternatively, the functional configurations and method described above may be actualized by a dedicated computer that is provided by a processor being configured by a single dedicated hardware logic circuit or more. Still alternatively, the functional configurations and method described above may be actualized by a single dedicated computer or more, the dedicated computer being configured by a combination of a processor that is programmed to provide one or a plurality of functions, a memory, and a processor that is configured by a single hardware logic circuit or more. In addition, the computer program may be stored in a non-transitory computer-readable storage medium that can be read by a computer as instructions performed by the computer.

What is claimed is:

1. An object detection apparatus that is mounted to a moving body to which a plurality of distance measurement sensors are mounted and detects an object that is present in a vicinity of the moving body, each of the distance measurement sensors outputting distance measurement information that corresponds to a distance to the object by transmitting probe waves externally from the moving body and receiving waves, as received waves, that include reflected waves of the probe waves from the object, the object detection apparatus comprising:
an object position acquiring unit that, in response to direct waves and indirect waves being received, acquires a relative position of the object to the moving body based on principles of triangulation using the distance measurement information based on the direct waves and the distance measurement information based on the indirect waves,
the direct waves being the received waves of a first distance measurement sensor that is one of the plurality of distance measurement sensors and being reflected waves of the probe waves that are transmitted from the first distance measurement sensor, and
the indirect waves being the received waves of a second distance measurement sensor that is another of the plurality of distance measurement sensors and being the reflected waves of the probe waves that are transmitted from the first distance measurement sensor; and
an object position estimating unit that, in response to the received waves being the reflected waves from the object of which the relative position has been already acquired by the object position acquiring unit and only either of the direct waves or the indirect waves being received as the received waves, estimates the relative position based on a reference position that is the relative position that has been already acquired.

2. The object detection apparatus according to claim 1, wherein:
the object position estimating unit estimates the relative position based on the reference position and the distance measurement information corresponding to the received waves.

3. The object detection apparatus according to claim 2, wherein:
the object detection estimating unit estimates the relative position based on an orientation of the reference position from the first distance measurement sensor and the distance measurement information corresponding to the received waves.

4. The object detection apparatus according to claim 1, wherein:
the object position estimating unit estimates the relative position when a difference between the distance measurement information corresponding to the reference position and the distance measurement information corresponding to the received waves is within a predetermined value.

5. The object detection apparatus according to claim 2, wherein:
the object position estimating unit estimates the relative position when a difference between the distance measurement information corresponding to the reference position and the distance measurement information corresponding to the received waves is within a predetermined value.

6. The object detection apparatus according to claim 3, wherein:
the object position estimating unit estimates the relative position when a difference between the distance measurement information corresponding to the reference position and the distance measurement information corresponding to the received waves is within a predetermined value.

7. An object detection method that is usable for a moving body to which a plurality of distance measurement sensors are mounted and detects an object that is present in a vicinity of the moving body, the distance measurement sensor outputting distance measurement information that corresponds to a distance to the object by transmitting probe waves externally from the moving body and receiving waves, as received waves, that include reflected waves of the probe waves from the object, the object detection method comprising:
acquiring, in response to direct waves and indirect waves being received, a relative position of the object to the moving body based on principles of triangulation using the distance measurement information based on the direct waves and the distance measurement information based on the indirect waves,
the direct waves being the received waves of a first distance measurement sensor that is one of the plurality of distance measurement sensors and being the reflected waves of the probe waves that are transmitted from the first distance measurement sensor, and
the indirect waves being the received waves of a second distance measurement sensor that is another of the plurality of distance measurement sensors and being the reflected waves of the probe waves that are transmitted from the first distance measurement sensor are both received; and
estimating, in response to the received waves being the reflected waves from the object of which the relative position has been already acquired and only either of the direct waves or the indirect waves being received as the received waves, the relative position based on a reference position that is the relative position that has been already acquired.

8. The object detection method according to claim 7, wherein:
the estimating step comprises
estimating the relative position based on the reference position and the distance measurement information corresponding to the received waves.

9. The object detection method according to claim 8, wherein:
the estimating step further comprises
estimating the relative position based on an orientation of the reference position from the first distance measurement sensor and the distance measurement information corresponding to the received waves.

10. The object detection method according to claim 7, wherein:
the estimating step comprises
estimating the relative position in response to a difference between the distance measurement information corresponding to the reference position and the distance measurement information corresponding to the received waves being within a predetermined value.

11. The object detection method according to claim 8, wherein:
the estimating step further comprises
estimating the relative position in response to a difference between the distance measurement information corresponding to the reference position and the distance measurement information corresponding to the received waves being within a predetermined value.

12. The object detection method according to claim 9, wherein:
the estimating step further comprises
estimating the relative position in response to a difference between the distance measurement information corresponding to the reference position and the distance measurement information corresponding to the received waves being within a predetermined value.
